(19) United States
(12) Patent Application Publication
(10) Pub. No.: US 2004/0234176 A1
(43) Pub. Date: Nov. 25, 2004

(54) Linear antifriction bearing element

(76) Inventors: Michael Sattler, Zweibrucken (DE); Martin Menges, Homburg (DE); Dietmar Rudy, Kleinbundenbach (DE)

Correspondence Address: MUSERLIAN AND LUCAS AND MERCANTI, LLP, 475 PARK AVENUE SOUTH, NEW YORK, NY, 10016, US

(21) Appl. No.: 10/485,322

(22) PCT Filed: Jul. 3, 2002
(86) PCT No.: PCT/EP02/07331

(30) Foreign Application Priority Data
Jul. 27, 2001 (DE) 101 36 826.7

(51) Int. Cl. F16C 29/06; F16C 33/10

(52) U.S. Cl. 384/13; 384/45

(57) ABSTRACT

In a linear rolling bearing element comprising a carrier body that is mounted through rolling elements for sliding on the running surface (5) of a guide rail (4), and, for forming a rolling element circuit, said bearing element further comprising a load-bearing zone and a return channel which extend parallel to the direction of movement of the linear rolling bearing element, said load-bearing zone and said return channel being connected to each other through deflecting channels that are arranged on the carrier body in frontally adjoining head pieces (11) that contain lubricant ducts starting at a filling point of each head piece (11) and leading to the rolling elements, at least one lubricant duct for a rolling element circuit is divided into a supply duct (13) and an exit duct (14), which supply and exit ducts (13, 14) are connected to each other by a sealable lubricant pocket (12).

### FIELD OF THE INVENTION

The invention concerns a linear rolling bearing element comprising a carrier body that is mounted through rolling elements for sliding on a running surface of a guide rail, and, for forming a rolling element circuit, said bearing element further comprising a load-bearing zone and a return channel which extend parallel to a direction of movement of the linear rolling bearing element, said load-bearing zone and said return channel being connected to each other through deflecting channels that are arranged on the carrier body in frontally adjoining head pieces comprising lubricant ducts that start at a filling point of each head piece and lead to the rolling elements.

### BACKGROUND OF THE INVENTION

A bearing element of the pre-cited type is known from the document DE 43 31 014 C2. In this prior art, a component formed out of an inner retaining plate and an outer retaining plate serves for the retention of a front wiper and also comprises channels for lubricant distribution. If the pressure of the lubricant in the channels drops, there is the risk of the lubricant channels or lubricant ducts running empty.

### OBJECTS OF THE INVENTION

It is an object of the invention to provide a linear rolling bearing element in which the lubrication of all running surfaces can be effected in a reliable and uniform manner.

This and other objects and advantages of the invention will become obvious from the following detailed description.

### SUMMARY OF THE INVENTION

The invention achieves the above objects by the fact that at least one lubricant duct for a rolling element circuit is divided into a supply duct and an exit duct, which supply and exit ducts are connected to each other by a sealable lubricant pocket. By integrating, in the lubricant duct, a lubricant pocket that must comprise an opening mechanism controlled by lubricant pressure, an emptying of the lubricant duct after a drop of pressure is prevented. Rollers, needles or balls may be used as rolling elements in such a bearing element.

In the linear rolling bearing element of the invention, the exit duct for the lubricant is tightly sealed towards the outside. The bearing element makes it possible to dose the lubricant or convey it in consumption-controlled quantities to its point of use.

The lubricant pocket can be configured in the form of a hollow cylinder into which an elastic stopper sealing the exit duct projects. For this purpose, it is also possible to use a stopper loaded by a compression spring. The elastic stopper may be made of a plastic or a rubber material, or also of a felt or a porous material.

A pressure plate may be arranged within the lubricant pocket to bear against the elastic stopper. This pressure plate may be made of a stiff rubber material. The material of the stopper may also extend within the exit duct and be in contact with the running surface of the guide rail.

### BRIEF DESCRIPTION OF THE DRAWING

Examples of embodiment of the invention are illustrated in the drawing and will be described more closely below.

FIG. 1 is an end view of a bearing element of the invention which is supported through rolling elements for longitudinal displacement on a guide rail;

FIG. 2 is an enlarged partial section through a head piece of the bearing element illustrated in FIG. 1;

FIG. 3 is a view similar to FIG. 2, but showing a modified elastic stopper;

FIG. 4 is a top view of a prior art bearing element arranged for longitudinal displacement on a guide rail;

FIG. 5 shows an end region of the carrier body, without head piece, of the bearing element of FIG. 4 in an enlarged representation.

### DETAILED DESCRIPTION OF THE DRAWING

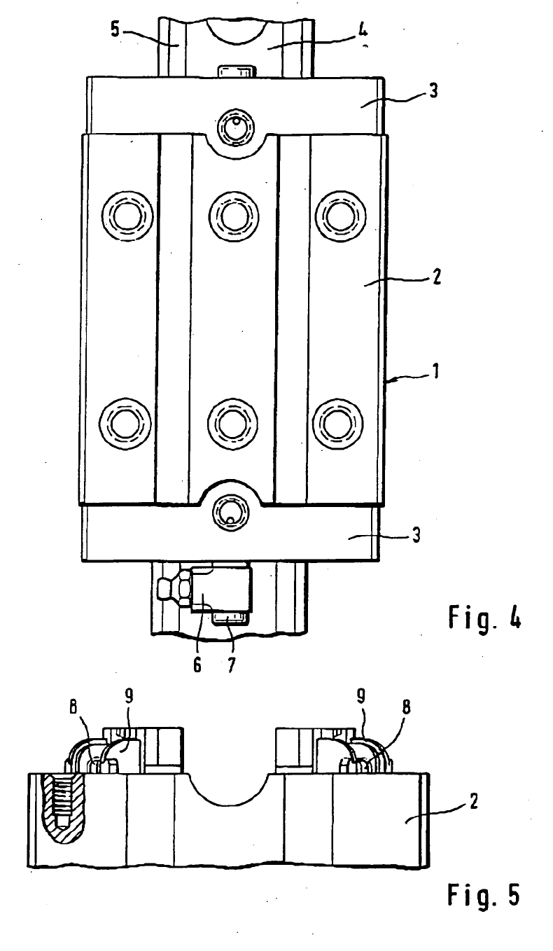

The prior art bearing element 1 illustrated in FIGS. 4 and 5 comprises two head pieces 3 fixed on ends of a carrier body 2. Each head piece 3 contains a deflecting body for deflecting rolling elements out of a load-bearing region into a returning region of the bearing element 1, or vice versa. The bearing element 1 with its two head pieces 3 can travel in a straight line along a guide rail 4 that comprises running surfaces 5 for rolling elements of the load-bearing region. A lubricating nipple carrier 6 with a lubricating nipple is fixed with a screw 7 on one of the head pieces 3. The lubricant supplied through the lubricating nipple is conveyed to the rolling elements through lubricant channels arranged in the head piece 3.

As can be seen in FIG. 5, guide webs for the rolling elements in the deflecting region project out of the carrier body 2 in end regions and, together with deflecting segments 8, form guide flanges 9 that serve for an exact guidance of the rolling elements in the deflecting region.

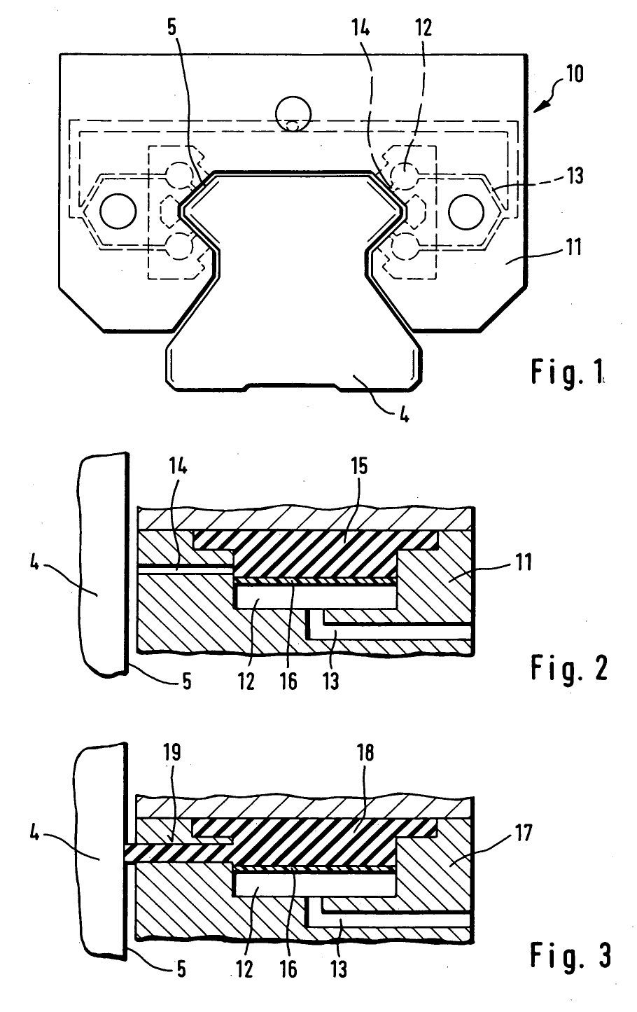

In the bearing element 10 of the invention illustrated in FIGS. 1 and 2, a head piece 11 comprises a lubricant pocket 12 into which a supply duct 13 opens and from which an exit duct 14 leads out of the head piece 11 to the running surface 5 of the guide rail 4 for the load-bearing rolling elements. The lubricant pocket 12 is configured as a hollow cylindrical recess. The supply duct 13 opens at the bottom of the lubricant pocket 12, while the exit duct 14 is connected to the lubricant pocket 12 at a point on the side wall of the cylinder. An elastic stopper 15 is inserted so far into the lubricant pocket 12 that the exit duct 14 is closed, so that lubricant cannot return into the lubricant pocket 12 through the exit duct 14.

The exit duct 14 does not open till the liquid pressure of the lubricant in the supply duct 13 and in the lubricant pocket 12 has become so high that the opposing, closing force of the elastic stopper 15 is overcome i.e., till the stopper has been sufficiently compressed. Following a lubricating pulse and the resulting drop of lubricant pressure, the elastic stopper 15 re-expands and thus closes the exit duct 14. An emptying of the lubricant duct, that is to say, an uncontrolled exit of lubricant, as is possible, for instance, in conventional open lubricant channels in head pieces of guide carriages of profiled rail guides, is prevented by the invention.

This leads to a reduction of lubricant requirement so that the re-lubrication intervals can be lengthened. Besides this, it is assured that several points of lubrication can be supplied simultaneously and uniformly with lubricant irrespective of the position of installation of the guide carriage. The quantity of lubricant flow can be dosed over the duration of oil pressure application.

To compensate for non-homogeneities in the elastic behavior of the stopper (in the case of felt, e.g., variations of the pressing factor), the lubricant pocket 12 acts on a large area of the elastic stopper 15 that produces the closing force. For this purpose, a pressure plate 16 made of a stiff rubber material can be additionally arranged under the elastic stopper 15.

The head piece 17 of the invention shown in FIG. 3 has basically the same structure as the head piece 11 of FIG. 2 but comprises an elastic stopper 18 that also extends in the exit duct 19 and, in this way, is directly connected to the running surface 5 or the rolling elements, i.e. the lubrication point. Independently of the opening pressure in the lubricant pocket, an additional,requirement-controlled lubricant exchange occurs under capillary action between the lubricant pocket 12 and the lubrication point, e.g. the running surface 5. The elastic stopper 18 that applies the closing force and, at the same time, conducts the lubricant can be made, for example, of a porous material or a laminate.

What is claimed is:

1. A linear rolling bearing element comprising a carrier body that is mounted through rolling elements for sliding on a running surface of a guide rail, and, for forming a rolling element circuit, said bearing element further comprising a load-bearing zone and a return channel which extend parallel to a direction of movement of the linear rolling bearing element, said load-bearing zone and said return channel being connected to each other through deflecting channels that are arranged on the carrier body in frontally adjoining head pieces comprising lubricant ducts that start at a filling point of each head piece and lead to the rolling elements, wherein at least one lubricant duct for a rolling element circuit is divided into a supply duct and an exit duct, which supply and exit ducts are connected to each other by a sealable lubricant pocket.

2. A bearing element of claim 1, wherein the exit duct ends on the running surface of the guide rail.

3. A bearing element of claim 1, wherein the lubricant pocket is made in the form of a hollow cylinder into which an elastic stopper that seals the exit duct projects.

4. A bearing element of claim 1, wherein the lubricant pocket is made in the form of a hollow cylinder into which a stopper that seals the exit duct and is loaded by a compression spring projects.

5. A bearing element of claim 3, wherein the elastic stopper is made of one of a plastic and a rubber material.

6. A bearing element of claim 3, wherein the elastic stopper is made of one of a felt and a porous material.

7. A bearing element of claim 3, wherein a pressure plate bearing against the elastic stopper is arranged within the lubricant pocket.

8. A bearing element of claim 7, wherein the pressure plate is made of a stiff rubber material.

9. A bearing element of claim 6, wherein the material of the elastic stopper also extends within the exit duct and is in contact with the running surface of the guide rail.
